(19) United States
(12) Patent Application Publication
(10) Pub. No.: US 2026/0187813 A1
(43) Pub. Date: Jul. 2, 2026

(54) METHOD, APPARATUS, DEVICE AND STORAGE MEDIUM FOR INFORMATION PROCESSING

(71) Applicants: Lemon Inc., Grand Cayman (KY); Beijing Zitiao Network Technology Co., Ltd., Beijing (CN)

(72) Inventors: Xiaojie JIN, Los Angeles, CA (US); Zhongwei Ren, Beijing (CN); Xun Guo, Beijing (CN); Bingyi Kang, Los Angeles, CA (US); Jiashi Feng, Singapore (SG)

(21) Appl. No.: 19/425,955

(22) Filed: Dec. 18, 2025

(30) Foreign Application Priority Data
Dec. 27, 2024 (CN) 202411967675.3

(51) Int. Cl. G06T 7/20; G06V 10/774

(52) U.S. Cl. CPC G06T 7/20; G06V 10/774; G06T 2207/20081

(57) ABSTRACT

Embodiments of the disclosure relate to a method, apparatus, device and computer-readable storage medium for information processing. The method includes: obtaining a first image associated with an interactive scene, the first image corresponding to a first moment; generating, with a generation model, a set of motion tokens based at least on a first image token corresponding to the first image, the set of motion tokens indicating motion information associated with a first period of time, the motion information being related to a change in the interactive scene within the first period of time; generating, with the generation model, a second image token based on the first image token and the set of motion tokens, the second image token corresponding to a predicted image of the interactive scene at a second moment; and determining, based on the first image and the predicted image, a trigger action in the interactive scene.

### CROSS-REFERENCE

This disclosure claims priority to Chinese Patent Application No. 202411967675.3, filed on Dec. 27, 2024 in the Chinese Intellectual Property Office and entitled “METHOD, APPARATUS, DEVICE, AND COMPUTER-READABLE STORAGE MEDIUM FOR INFORMATION PROCESSING”, the disclosure of which is incorporated by reference herein in its entirety.

### FIELD

Example embodiments of the present disclosure generally relate to the field of computers, and in particular, to a method, apparatus, device, and computer-readable storage medium for information processing.

### BACKGROUND

Visual inference refers to a capability enabling a computer system to extract deep level semantic information from visual data and conduct logical inference and decision-making based on the information. This capability requires that the system not only recognizes objects and scenes in images or videos, but also understands the interrelationship between objects, predicts the consequences of actions, and makes reasonable planning and decisions in complex environments.

### SUMMARY

In a first aspect of the present disclosure, a method for information processing is provided. The method includes: obtaining a first image associated with an interactive scene, the first image corresponding to a first moment; generating, with a generation model, a set of motion tokens based at least on a first image token corresponding to the first image, the set of motion tokens indicating motion information associated with a first period of time, the motion information being related to a change in the interactive scene within the first period of time; generating, with the generation model, a second image token based on the first image token and the set of motion tokens, the second image token corresponding to a predicted image of the interactive scene at a second moment; and determining, based on the first image and the predicted image, a trigger action in the interactive scene.

In a second aspect of the present disclosure, an apparatus for information processing is provided. The apparatus includes: an image obtaining module configured to obtain a first image associated with an interactive scene, the first image corresponding to a first moment; a first generation module configured to generate, with a generation model, a set of motion tokens based at least on a first image token corresponding to the first image, the set of motion tokens indicating motion information associated with a first period of time, the motion information being related to a change in the interactive scene in the first period of time; a second generation module configured to generate, with the generation model, a second image token based on the first image token and the set of motion tokens, the second image token corresponding to a predicted image of the interactive scene at a second moment; and an action determination module configured to determine, based on the first image and the predicted image, a trigger action in the interactive scene.

In a third aspect of the present disclosure, an electronic device is provided. The electronic device includes at least one processor; and at least one memory coupled to the at least one processor and storing instructions for execution by the at least one processor. When executed by the at least one processor, the instructions cause the electronic device to perform the method of the first aspect.

In a fourth aspect of the present disclosure, a computer program product is provided. The computer program product is tangibly embodied on a non-transitory computer-readable storage medium and comprises instructions that, when executed by at least one computing device, are configured to cause the at least one computing device to perform the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent with reference to the following detailed description taken in conjunction with the accompanying drawings. In the drawings, the same or similar numerals refer to the same or similar elements, where:

FIG. 1 illustrates a schematic diagram of an example environment in which embodiments according to the present disclosure may be implemented;

FIG. 2A illustrates an example application process of a visual inference system according to some embodiments of the present disclosure;

FIG. 2B illustrates an example process of training a generation model according to some embodiments of the present disclosure;

FIG. 2C illustrates an example process of training an encoder according to some embodiments of the present disclosure;

FIG. 3 shows a schematic block diagram of an example process of information processing according to some embodiments of the present disclosure;

FIG. 4 illustrates a schematic structural block diagram of an example apparatus for information processing according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

It should be noted that the title of any section/subsection provided herein is not limited. Various embodiments are described throughout and any type of embodiments may be included in any section/subsection. Furthermore, the embodiments described in any section/subsection may be combined in any manner with any other embodiment described in the same section/subsection and/or different sections/subsections.

In the description of the embodiments of the present disclosure, the terms “including” and the like should be understood to include “including but not limited to”. The term “based on” should be understood as “at least partially based on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, obtaining and/or use of the data, and the like. These aspects all follow the corresponding laws and regulations and related provisions. In the embodiments of the present disclosure, the collecting, obtaining, processing, manufacturing, forwarding, using and so on of all data are conducted on the premise that the user knows and confirms. Accordingly, when implementing the embodiments of the present disclosure, the types, the usage scope, the usage scene, and the like of the data or information that may be involved, should be notified to the user and obtain the authorization of the user in an appropriate manner according to the relevant laws and regulations. The specific notification and/or authorization manner may vary according to actual situations and application scenes, and the scope of the present disclosure is not limited in this respect.

In the solutions of the present specification and the embodiments, if personal information processing is involved, the personal information processing will be processed on the premise of having a legality basis (for example, obtaining consent of a personal information subject, or necessary for fulfilling a contract), and the processing will only be within a specified or agreed range. The user's rejection on processing personal information other than necessary information required by the basic function, will not affect the user to use basic functions.

In the study of visual inference, traditional models often depend on text input, which limits their capability to process visual information. Secondly, these models usually require a large amount of annotation data for training, which is not only costly and time-consuming, but also has a limited generalization capability when facing new, unseen scenes.

On the other hand, the decision process of deep learning models often lacks transparency and interpretability, which is a significant drawback in applications that require a transparent model decision process and interpretability. In reinforcement learning, models often depend on search algorithms and reward mechanisms to learn strategies, which may be inefficient in complex environments and difficult to extend to broader tasks. At the same time, a sparsity of the visual representation causes knowledge representations to be too dispersed, which is not conducive for the models to effectively capture and generalize the knowledge.

Embodiments of the present disclosure provide a solution for information processing. The solution includes: obtaining a first image associated with an interactive scene, the first image corresponding to a first moment; generating, with a generation model, a set of motion tokens based at least on a first image token corresponding to the first image, the set of motion tokens indicating motion information associated with a first period of time, the motion information being related to a change in the interactive scene within the first period of time; generating, with the generation model, a second image token based on the first image token and the set of motion tokens, the second image token corresponding to a predicted image of the interactive scene at a second moment; and determining, based on the first image and the predicted image, a trigger action in the interactive scene.

In this way, the embodiments of the present disclosure can learn the basic knowledge with the video generation process, thereby improving the inference capability and long-term planning capability of the model in the visual task.

Various example implementations of this solution are described in detail below in connection with the accompanying drawings.

### Example Environment

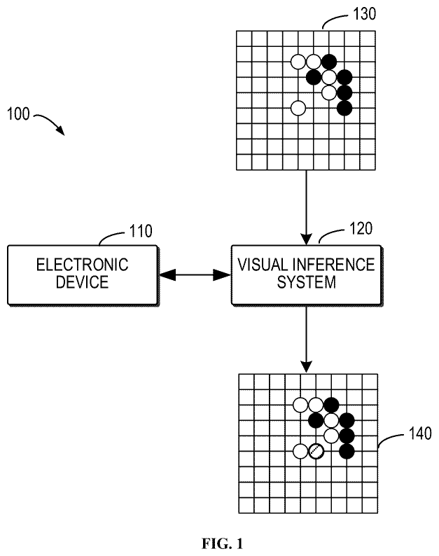

FIG. 1 illustrates a schematic diagram of an example environment 100 in which embodiments of the present disclosure may be implemented. As shown in FIG. 1, the example environment 100 may include an electronic device 110.

In this example environment 100, the electronic device 110 may deploy the visual inference system 120. The visual inference system 120 may obtain an image 130 associated with the interactive scene and generate a predicted image 140 of a next moment through the image generation task. Further, the visual inference system 120 may further determine, based on the image 130 and the predicted image 140, a trigger action in the interactive scene.

Taking the Go scene as an example, the visual inference system 120 may, for example, obtain the image 130 as observation information of the environment, and may generate the image 140 of the next moment. Compared to the image 130, the image 140 of the next moment may indicate a change of Go stones, and may therefore be used to determine an action to be executed, for example, placing a black stone at a specified position.

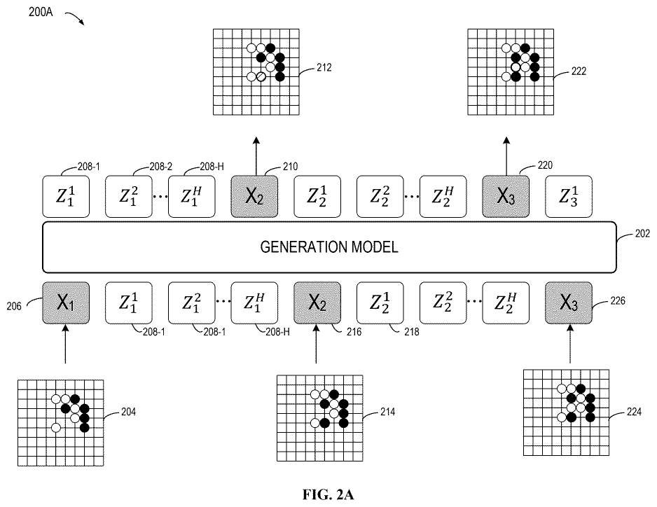

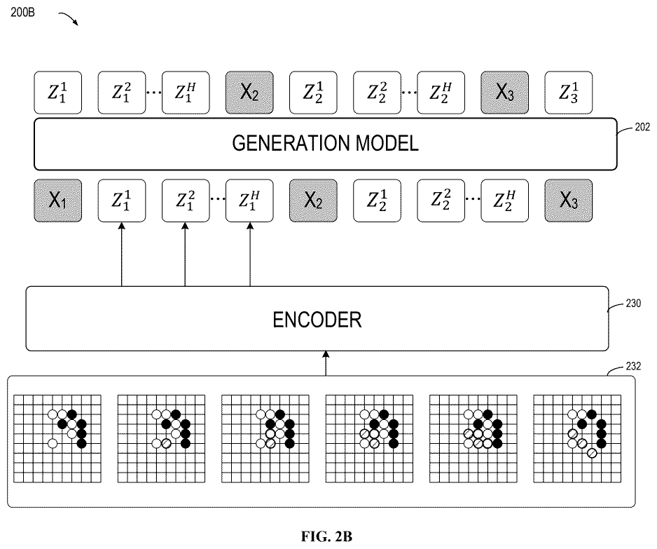

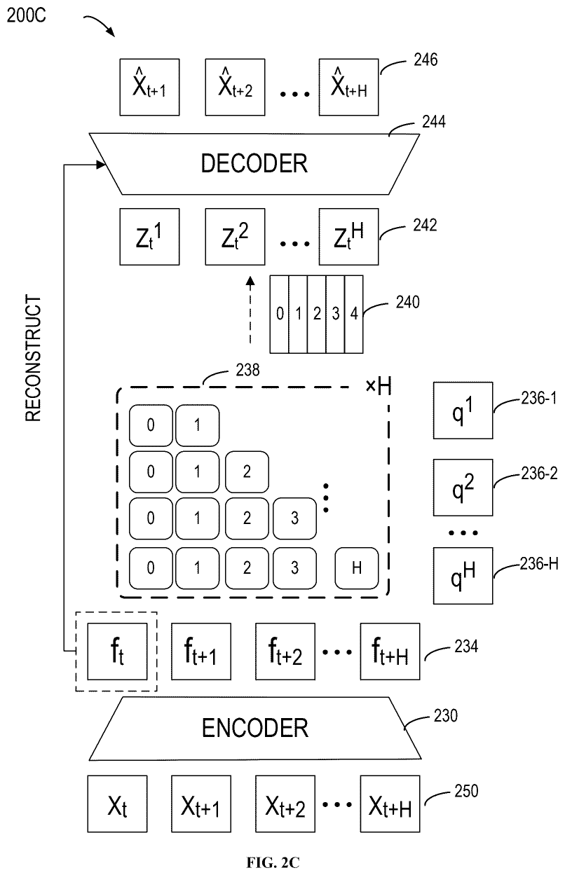

The specific structure and the processing process of the visual inference system 120 will be described in detail below with reference to FIGS. 2A and 2B.

The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a user (such as a “wearable” circuit, etc.).

The electronic device 110 may also be an independent physical server, or may be a server cluster composed of multiple physical servers or a distributed system composed of multiple physical servers, or may be a cloud server that provides basic cloud computing services such as cloud service, cloud database, cloud computing, cloud function, cloud storage, network service, cloud communication, middleware service, domain name service, security service, content distribution network, and big data and artificial intelligence platforms and so on. The electronic device 110 may include, for example, a computing system/server, such as a mainframe, an edge computing node, a computing device in a cloud environment, or the like.

It should be understood that the structures and functions of the various elements in the environment 100 are described for illustrative purposes only and do not imply any limitation to the scope of the present disclosure.

Some example embodiments of the present disclosure will be described below with continued reference to the accompanying drawings.

### Example Application Stage

FIG. 2A illustrates an example application process 200A of a visual inference system according to some embodiments of the present disclosure. As shown in FIG. 2A, the visual inference system 120 may include a generation model 202. In some embodiments, the generation model 202 may be, for example, an autoregressive model, such as an autoregressive transformer. The generation model 202 may, for example, output a processing result based on a token prediction manner.

As shown in FIG. 2A, the visual inference system 120 may obtain a first image 204 associated with an interactive scene. The first image 204 may correspond to a state of an interactive scene at a first moment. Continuing to take the Go as an example of an interactive scene, the first image 204 may indicate a stone distribution of the Go at the first moment.

In some embodiments, the visual inference system 120 may encode the first image 204 with an image encoder and may process an encoded feature of the first image 204 with a tokenizer, thereby obtaining the first image token 206, i.e., x₁.

Further, the visual inference system 120 may process the first image token 206 to generate motion information associated with a first period of time. Specifically, as shown in FIG. 2A, the visual inference system 120 may generate a set of motion tokens, i.e., motion tokens 208-1 to 208-H (individually or collectively referred to as motion token 208).

In some embodiments, the motion token 208 may indicate a change in the interactive scene within a first period of time (e.g., H image frames) in the future. As an example, the token

$${z}_{1}^{1}$$

208-1 may indicate a change in a first frame image after the first moment relative to the first image 204; the token

$${z}_{1}^{2}$$

208-2 may indicate a change in a second frame image after the first moment relative to the first image 204.

As shown in FIG. 2A, the generation model 202 may output the set of motion tokens 208 token-by-token. That is, the generation model 202 may generate the token

$${z}_{1}^{1}$$

208-1 based on the first image token 206, and may further generate the token

$${z}_{1}^{2}$$

208-2 based on the first image token 206 and the token

$${z}_{1}^{1}$$

208-1.

Further, the generation model 202 may further generate a second image token 210 based on the first image token 206 and the first set of motion tokens 208. The second image token 210 may correspond to a predicted image 212 of the interactive scene at a second moment.

Further, the visual inference system 120 may determine, based on the first image 204 and the predicted image 212, a trigger action in the interactive scene. Taking the Go scene as an example, the visual inference system 120 may determine to place the black stone at which position based on the first image 204 and the predicted image 212.

In some embodiments, to improve the accuracy of the determined trigger action, the visual inference system 120 may also provide the first image 204, the predicted image 212, and the set of motion tokens 208 to an action model to determine the trigger action in the interactive scene. The process may be, for example, represented as:

$$π ( \cdot \vert {x}_{t} , {\hat{x}}_{t + 1} , {\{ {\hat{z}}_{t}^{h} \}}_{h = 1}^{H} ) \qquad ( 1 )$$

Where xₜ represents an image of the interactive scene at the first moment, \hat{x}ₜ₊₁ represents the predicted image at the second moment, and

$${\{ {\hat{z}}_{t}^{h} \}}_{h = 1}^{H}$$

represents the motion token generated by the generation model 202.

In some embodiments, the action model may include, for example, a plurality of Multilayer Perceptron (MLP) layers, and may be trained with video data and corresponding action annotation data.

In some embodiments, the visual inference system 120 may further control an action executor associated with the interactive scene to execute the determined trigger action. It should be understood that such an action executor may include, for example, software, hardware, and/or a combination thereof.

Taking the Go scene as an example, if corresponding to a virtual interactive scene, the visual inference system 120 may, for example, trigger the Go application to place a stone at a corresponding position. If the Go scene corresponds to a robot scene, the visual inference system 120 may, for example, drive a robotic arm to place a stone at a corresponding position.

It should be understood that although the process of executing the visual inference based on the video generation task is described above with reference to the Go scene as an example, the embodiments of the present disclosure are also applicable to other suitable visual inference scenes. For example, a visual inference model for controlling the robotic arm may be trained and deployed to drive the robotic arm to execute the corresponding action based on the image of the operating environment. In some embodiments, different interactive scenes may be processed with different visual inference systems.

With continued reference to FIG. 2A, after the trigger action is executed, the visual inference system 120 may obtain the second image 214 of the interactive scene at the second moment. For example, the second image 214 may correspond to a chessboard image after the black stone is placed at a specified position.

Similarly, the visual inference system 120 may obtain a third image token 216 corresponding to the second image 214. Further, as shown in FIG. 2A, the generation model 202 may generate a second set of motion tokens, e.g., the motion token 218, associated with a second period of time based on the first image token 206, the set of motion tokens 208 and the third image token 216.

Furthermore, the generation model 202 may generate a fourth image token 220 based on the first image token 206, the first set of motion tokens 208, the third image token 216, and the second set of motion tokens 218. The fourth image token 220 may correspond to the predicted image 222 of the interactive scene at a third moment.

The visual inference system 120 may further determine an additional trigger action in the interactive scene based on the second image 214 and the predicted image 222. For example, the visual inference system 120 may provide the second image 214, the predicted image 222, and the second set of motion tokens 218 to the action model to generate the additional trigger action. As an example, the additional trigger action may indicate to place a white stone at a specified position in the chessboard.

Similarly, after the additional trigger action is executed, the visual inference system 120 may obtain a third image 224 of the interactive scene at the third moment, and may perform a subsequent token generation process according to the corresponding fifth image token 226.

In this way, the embodiments of the present disclosure can improve the processing capability of the visual inference system.

### Example Training Stage

The training process of the visual inference system 120 will be described further below with reference to FIG. 2B and FIG. 2C. FIG. 2B illustrates an example process 200B for training a generation model 202.

As shown in FIG. 2B, the visual inference system 120 may obtain a first video frame and a subsequent first set of video frames in a first training video 232. Taking FIG. 2B as an example, the first video frame may include a video frame of the first training video 232 at moment t, and the first set of video frames may correspond to a plurality of video frames from moment t+1 to moment t+H.

Further, the visual inference system 120 may process, with an encoder 230, the first video frame and the first set of video frames, thereby generating a first set of training motion tokens, e.g.,

$${z}_{1}^{1} , {z}_{1}^{2} to {z}_{1}^{H} .$$

As mentioned above, the training motion token

$${z}_{t}^{t + n}$$

may represent a difference between the video frame at the t+n th moment and the video frame at the t th moment.

In this way, the visual inference system 120 may construct a training token sequence based on the first training video 232, which may include image tokens corresponding to video frames at a plurality of moments, a set of motion tokens corresponding to the video frame. Further, the visual inference system 120 may train the generation model 202 based on the constructed training token sequence. As an example, the visual inference system 120 may adjust a parameter of the autoregressive model based on a training loss of the autoregressive model.

The specific training process of the encoder 230 will be further described below with reference to FIG. 2C. In some embodiments, the encoder 230 may be, for example, an encoder in a causal encoder-decoder.

As shown in FIG. 2C, the visual inference system 120 may obtain a second video frame xₜ and a subsequent second set of video frames xₜ₊₁ to x_{t+H} in the second training video 250.

Further, the visual inference system 120 may process, with the encoder 230, the second video frame xₜ and the second set of video frames xₜ₊₁ to x_{t+H}, to generate a second set of training motion tokens 242, e.g.,

$${z}_{t}^{1} , {z}_{t}^{2} to {z}_{t}^{H} .$$

The second set of training motion tokens 242 indicates a difference of the second set of video frames xₜ₊₁ to x_{t+H} relative to the second video frame xₜ.

The visual inference system 120 may generate, with the decoder 244, a set of predicted video frames 246, i.e., \hat{x}ₜ₊₁ to \hat{x}_{t+H}, based on the second video frame xₜ and the second set of training motion tokens 242.

Specifically, as shown in FIG. 2C, the visual inference system 120 may generate, with the encoder 230, a plurality of image coding 234, i.e., fₜ to f_{t+H}, corresponding to the second video frame xₜ and the subsequent second set of video frames xₜ₊₁ to x_{t+H}. Furthermore, the encoder 230 may further include a plurality of attention units to generate a plurality of query features, i.e., query features 236-1 to 236-H (also referred to as query feature 236) based on the plurality of image coding 234.

In some embodiments, the query feature 236-1 to the query feature 236-H may correspond to different time ranges, which may be used to indicate differences of different video frames relative to a starting video frame. For example, the query feature 236-H may represent the difference of the video frame x_{t+H} relative to the video frame xₜ. In some embodiments, the visual inference system 120 may generate, with an attention mask 238, the query feature 236 corresponding to different time ranges.

Furthermore, the encoder 230 may also quantize, with codebook based information 240, the obtained set of query features 236, thereby taking the determined at least one quantization representation as the training motion token 242.

In addition, the visual inference system 120 may adjust a parameter of the encoder 230 based on a comparison of the set of predicted video frames 246 (\hat{x}ₜ₊₁ to \hat{x}_{t+H}) and the second set of video frames xₜ₊₁ to x_{t+H}, thereby completing the training of the encoder. For example, the visual inference system 120 may train the causal encoder-decoder based on a reconstruction loss of the image to enable the encoder to generate a motion token representing the motion information.

In this way, by utilizing the autoregressive video generation model, and in connection with motion tokens representing changes between video frames, embodiments of the present disclosure not only can capture the details of the visual information, but also can understand and predict the evolution of the visual dynamics.

In addition, this compact visual representation can enhance the inference capability of the visual inference system, especially in tasks requiring long-term planning and complex decisions. For example, in a Go scene, rather than depending only on the current state, the visual inference system can formulate the strategy by predicting the moves of several future steps. This capability enables the visual inference system to make a high-quality decision without using a search algorithm or a typical reward mechanism in reinforcement learning.

### Example Process

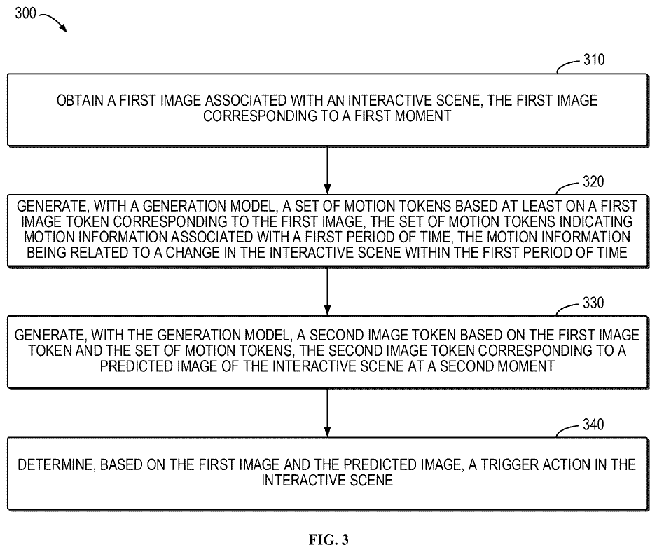

FIG. 3 illustrates a schematic diagram of an example information processing process 300 according to some embodiments of the present disclosure. Process 300 may be performed, for example, by visual inference system 120 as shown in FIG. 1.

As shown in FIG. 3, at block 310, the visual inference system 120 obtains a first image associated with an interactive scene, the first image corresponding to a first moment.

At block 320, the visual inference system 120 generates, with a generation model, a set of motion tokens based at least on a first image token corresponding to the first image, the set of motion tokens indicating motion information associated with a first period of time, the motion information being related to a change in the interaccotive scene within the first period of time.

At block 330, the visual inference system 120 generates, with the generation model, a second image token based on the first image token and the set of motion tokens, the second image token corresponding to a predicted image of the interactive scene at a second moment.

At block 340, the visual inference system 120 determines, based on the first image and the predicted image, a trigger action in the interactive scene.

In some embodiments, the set of motion tokens is a first set of motion tokens, the predicted image is a first predicted image, the trigger action is a first trigger action, and the process 300 further includes: obtaining a second image of the interactive scene at the second moment; generating, with the generation model, a second set of motion tokens associated with a second period of time based on the first image token, the first set of motion tokens and a third image token corresponding to the second image; generating, with the generation model, a fourth image token based on the first image token, the first set of motion tokens, the third image token and the second set of motion tokens, the fourth image token corresponding to a second predicted image of the interactive scene at a third moment; and determining, based on the second image and the second predicted image, a second trigger action in the interactive scene.

In some embodiments, the set of motion tokens includes a first motion token and a second motion token, and the second motion token is generated further based on the first motion token.

In some embodiments, determining the trigger action in the interactive scene based on the first image and the predicted image includes: providing the first image, the predicted image and the set of motion tokens to an action model to determine the trigger action in the interactive scene.

In some embodiments, the generation model is trained based on the following process: obtaining a first video frame and a subsequent first set of video frames in a first training video; processing, with an encoder, the first video frame and the first set of video frames to generate a first set of training motion tokens indicating a difference of the first set of video frames relative to the first video frame; constructing a training token sequence based on a training image token corresponding to the first video frame and the first set of training motion tokens; and training the generation model based on the training token sequence.

In some embodiments, the set of training motion tokens includes at least one quantization representation determined based on codebook information.

In some embodiments, the encoder is trained based on the following process: obtaining a second video frame and a subsequent second set of video frames in a second training video; processing, with an encoder, the second video frame and the second set of video frames to generate a second set of training motion tokens indicating a difference of the second set of video frames relative to the second video frame; generating, with a decoder, a set of predicted video frames based on the second video frame and the second set of training motion tokens; and adjusting a parameter of the encoder based on a comparison of the set of predicted video frames and the second set of video frames.

In some embodiments, the encoder includes a plurality of attention units configured to generate a plurality of query features indicating differences of different video frames in the first set of video frames relative to the first video frame.

In some embodiments, the process 300 further includes controlling an action executor associated with the interactive scene to execute the determined trigger action.

### Example Apparatus and Device

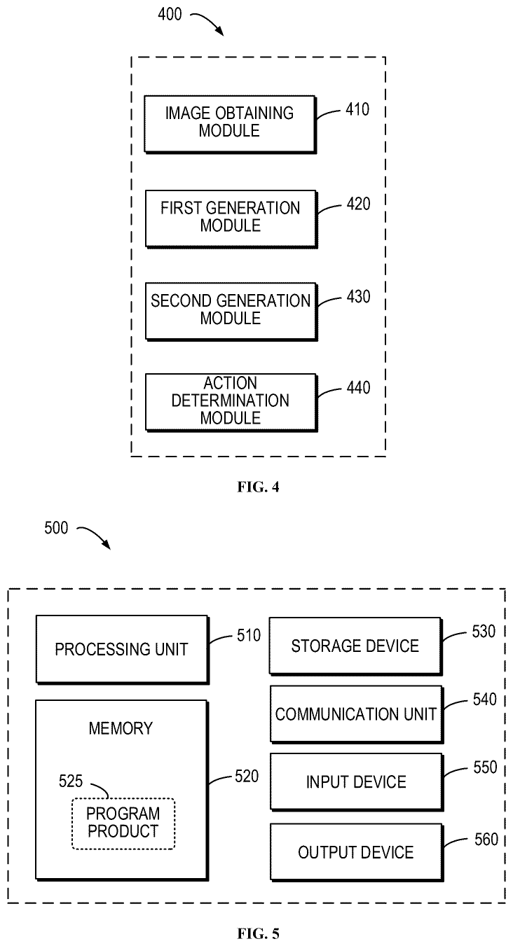

Embodiments of the present disclosure also provide a corresponding apparatus for implementing the above method or process. FIG. 4 shows a schematic structural block diagram of an example apparatus 400 for information processing according to some embodiments of the present disclosure. The apparatus 400 may be implemented as or included in the electronic device 110. The various modules/components in the apparatus 400 may be implemented by hardware, software, firmware, or any combination thereof.

As shown in FIG. 4, the apparatus 400 includes an image obtaining module configured to obtain a first image associated with an interactive scene, the first image corresponding to a first moment; a first generation module configured to generate, with a generation model, a set of motion tokens based at least on a first image token corresponding to the first image, the set of motion tokens indicating motion information associated with a first period of time, the motion information being related to a change in the interactive scene in the first period of time; a second generation module configured to generate, with the generation model, a second image token based on the first image token and the set of motion tokens, the second image token corresponding to a predicted image of the interactive scene at a second moment; and an action determination module configured to determine, based on the first image and the predicted image, a trigger action in the interactive scene.

In some embodiments, wherein the set of motion tokens is a first set of motion tokens, the predicted image is a first predicted image, the trigger action is a first trigger action. The apparatus 400 further includes a third generation module configured to obtain a second image of the interactive scene at the second moment; generate, with the generation model, a second set of motion tokens associated with a second period of time based on the first image token, the first set of motion tokens and a third image token corresponding to the second image; generate, with the generation model, a fourth image token based on the first image token, the first set of motion tokens, the third image token and the second set of motion tokens, the fourth image token corresponding to a second predicted image of the interactive scene at a third moment; and determine, based on the second image and the second predicted image, a second trigger action in the interactive scene.

In some embodiments, the set of motion tokens includes a first motion token and a second motion token, and the second motion token is generated further based on the first motion token.

In some embodiments, the action determination module is further configured to provide the first image, the predicted image and the set of motion tokens to an action model to determine the trigger action in the interactive scene.

In some embodiments, the generation model is trained based on the following process: obtaining a first video frame and a subsequent first set of video frames in a first training video; processing, with an encoder, the first video frame and the first set of video frames to generate a first set of training motion tokens indicating a difference of the first set of video frames relative to the first video frame; constructing a training token sequence based on a training image token corresponding to the first video frame and the first set of training motion tokens; and training the generation model based on the training token sequence.

In some embodiments, the set of training motion tokens includes at least one quantization representation determined based on codebook information.

In some embodiments, the encoder is trained based on the following process: obtaining a second video frame and a subsequent second set of video frames in a second training video; processing, with an encoder, the second video frame and the second set of video frames to generate a second set of training motion tokens indicating a difference of the second set of video frames relative to the second video frame; generating, with a decoder, a set of predicted video frames based on the second video frame and the second set of training motion tokens; and adjusting a parameter of the encoder based on a comparison of the set of predicted video frames and the second set of video frames.

In some embodiments, the encoder includes a plurality of attention units configured to generate a plurality of query features indicating differences of different video frames in the first set of video frames relative to the first video frame.

In some embodiments, the apparatus 400 further includes an action execution module configured to control an action executor associated with the interactive scene to execute the determined trigger action.

FIG. 5 illustrates a block diagram of an electronic device capable of implementing one or more embodiments of the present disclosure. It should be understood that the electronic device 500 illustrated in FIG. 5 is merely illustrative and should not constitute any limitation on the functionality and scope of the embodiments described herein. The electronic device 500 shown in FIG. 5 may be used to implement the electronic device 110 of FIG. 1.

As shown in FIG. 5, the electronic device 500 is in the form of a general-purpose electronic device. The components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, multiple processing units execute computer-executable instructions in parallel to improve parallel processing capabilities of electronic device 500.

Electronic device 500 typically includes a plurality of computer storage medium. Such medium may be any available medium accessible to the electronic device 500, including, but not limited to, volatile and non-volatile medium, removable and non-removable medium. The memory 520 may be volatile memory (e.g., registers, caches, random access memory (RAM)), non-volatile memory (e.g., a read-only memory (ROM), electrically erasable programmable read-only memory (EEPROM), flash memory), or some combination thereof. Storage device 530 may be a removable or non-removable medium and may include a machine-readable medium, such as a flash drive, magnetic disk, or any other medium, which may be capable of storing information and/or data and may be accessed within electronic device 500.

The electronic device 500 may further include additional removable/non-removable, volatile/non-volatile storage medium. Although not shown in FIG. 5, a disk drive for reading or writing from a removable, non-volatile magnetic disk (e.g., a “floppy disk”) and an optical disk drive for reading or writing from a removable, non-volatile optical disk may be provided. In these situations, each drive may be connected to a bus (not shown) by one or more data medium interfaces. The memory 520 may include a computer program product 525 having one or more program modules configured to perform various methods or actions of various embodiments of the present disclosure.

The communication unit 540 implements communications with other electronic devices through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, where the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Various aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer-readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce apparatus to implement the functions/actions specified in one or more blocks of the flowchart and/or block diagram. These computer-readable program instructions may also be stored in a computer-readable storage medium that cause the computer, programmable data processing apparatus, and/or other devices to function in a particular manner, such that the computer-readable medium storing instructions includes a manufactured product including instructions to implement aspects of the functions/actions specified in one or more blocks of the flowchart and/or block diagram.

The computer-readable program instructions may be loaded onto a computer, other programmable data processing apparatus, or other device, such that a series of operational steps are performed on a computer, other programmable data processing apparatus, or other device to produce a computer-implemented process such that the instructions executed on a computer, other programmable data processing apparatus, or other device implement the functions/actions specified in one or more blocks of the flowchart and/or block diagram.

The flowchart and block diagrams in the drawings show architecture, functionality, and operation possibly implement by systems, methods, and computer program products according to various implementations of the present disclosure. In this regard, each block in the flowchart or block diagram may represent a module, program segment, or portion of an instruction that contains one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles and practical applications of the implementations, or improvements to techniques in the marketplace, or to enable others of ordinary skill in the art to understand the various implementations disclosed herein.

1. A method for information processing, comprising:
obtaining a first image associated with an interactive scene, the first image corresponding to a first moment;
generating, with a generation model, a set of motion tokens based at least on a first image token corresponding to the first image, the set of motion tokens indicating motion information associated with a first period of time, the motion information being related to a change in the interactive scene within the first period of time;
generating, with the generation model, a second image token based on the first image token and the set of motion tokens, the second image token corresponding to a predicted image of the interactive scene at a second moment; and
determining, based on the first image and the predicted image, a trigger action in the interactive scene.

2. The method of claim 1, wherein the set of motion tokens is a first set of motion tokens, the predicted image is a first predicted image, the trigger action is a first trigger action, and the method further comprises:
obtaining a second image of the interactive scene at the second moment;
generating, with the generation model, a second set of motion tokens associated with a second period of time based on the first image token, the first set of motion tokens and a third image token corresponding to the second image;
generating, with the generation model, a fourth image token based on the first image token, the first set of motion tokens, the third image token and the second set of motion tokens, the fourth image token corresponding to a second predicted image of the interactive scene at a third moment; and
determining, based on the second image and the second predicted image, a second trigger action in the interactive scene.

3. The method of claim 1, wherein the set of motion tokens comprises a first motion token and a second motion token, and the second motion token is generated further based on the first motion token.

4. The method of claim 1, wherein determining the trigger action in the interactive scene based on the first image and the predicted image comprises:
providing the first image, the predicted image and the set of motion tokens to an action model to determine the trigger action in the interactive scene.

5. The method of claim 1, wherein the generation model is trained based on the following process:
obtaining a first video frame and a subsequent first set of video frames in a first training video;
processing, with an encoder, the first video frame and the first set of video frames to generate a first set of training motion tokens indicating a difference of the first set of video frames relative to the first video frame;
constructing a training token sequence based on a training image token corresponding to the first video frame and the first set of training motion tokens; and
training the generation model based on the training token sequence.

6. The method of claim 5, wherein the set of training motion tokens comprises at least one quantization representation determined based on codebook information.

7. The method of claim 5, wherein the encoder is trained based on the following process:
obtaining a second video frame and a subsequent second set of video frames in a second training video;
processing, with an encoder, the second video frame and the second set of video frames to generate a second set of training motion tokens indicating a difference of the second set of video frames relative to the second video frame;
generating, with a decoder, a set of predicted video frames based on the second video frame and the second set of training motion tokens; and
adjusting a parameter of the encoder based on a comparison of the set of predicted video frames and the second set of video frames.

8. The method of claim 5, wherein the encoder comprises a plurality of attention units configured to generate a plurality of query features indicating differences of different video frames in the first set of video frames relative to the first video frame.

9. The method of claim 1, further comprising:
controlling an action executor associated with the interactive scene to execute the determined trigger action.

10. An electronic device, comprising:
at least one processor; and
at least one memory coupled to the at least one processor and storing instructions for execution by the at least one processor, wherein the instructions, when executed by the at least one processor, cause the electronic device to perform operations comprising:
obtaining a first image associated with an interactive scene, the first image corresponding to a first moment;
generating, with a generation model, a set of motion tokens based at least on a first image token corresponding to the first image, the set of motion tokens indicating motion information associated with a first period of time, the motion information being related to a change in the interactive scene within the first period of time;
generating, with the generation model, a second image token based on the first image token and the set of motion tokens, the second image token corresponding to a predicted image of the interactive scene at a second moment; and
determining, based on the first image and the predicted image, a trigger action in the interactive scene.

11. The electronic device of claim 10, wherein the set of motion tokens is a first set of motion tokens, the predicted image is a first predicted image, the trigger action is a first trigger action, and the operations further comprise:
obtaining a second image of the interactive scene at the second moment;
generating, with the generation model, a second set of motion tokens associated with a second period of time based on the first image token, the first set of motion tokens and a third image token corresponding to the second image;
generating, with the generation model, a fourth image token based on the first image token, the first set of motion tokens, the third image token and the second set of motion tokens, the fourth image token corresponding to a second predicted image of the interactive scene at a third moment; and
determining, based on the second image and the second predicted image, a second trigger action in the interactive scene.

12. The electronic device of claim 10, wherein the set of motion tokens comprises a first motion token and a second motion token, and the second motion token is generated further based on the first motion token.

13. The electronic device of claim 10, wherein determining the trigger action in the interactive scene based on the first image and the predicted image comprises:
providing the first image, the predicted image and the set of motion tokens to an action model to determine the trigger action in the interactive scene.

14. The electronic device of claim 10, wherein the generation model is trained based on the following process:
obtaining a first video frame and a subsequent first set of video frames in a first training video;
processing, with an encoder, the first video frame and the first set of video frames to generate a first set of training motion tokens indicating a difference of the first set of video frames relative to the first video frame;
constructing a training token sequence based on a training image token corresponding to the first video frame and the first set of training motion tokens; and
training the generation model based on the training token sequence.

15. The electronic device of claim 14, wherein the set of training motion tokens comprises at least one quantization representation determined based on codebook information.

16. The electronic device of claim 14, wherein the encoder is trained based on the following process:
obtaining a second video frame and a subsequent second set of video frames in a second training video;
processing, with an encoder, the second video frame and the second set of video frames to generate a second set of training motion tokens indicating a difference of the second set of video frames relative to the second video frame;
generating, with a decoder, a set of predicted video frames based on the second video frame and the second set of training motion tokens; and
adjusting a parameter of the encoder based on a comparison of the set of predicted video frames and the second set of video frames.

17. The electronic device of claim 14, wherein the encoder comprises a plurality of attention units configured to generate a plurality of query features indicating differences of different video frames in the first set of video frames relative to the first video frame.

18. The electronic device of claim 10, wherein the operations further comprise:
controlling an action executor associated with the interactive scene to execute the determined trigger action.

19. A computer program product tangibly embodied on a non-transitory computer-readable storage medium and comprising instructions that, when executed by at least one computing device, are configured to cause the at least one computing device to perform operations comprising:
obtaining a first image associated with an interactive scene, the first image corresponding to a first moment;
generating, with a generation model, a set of motion tokens based at least on a first image token corresponding to the first image, the set of motion tokens indicating motion information associated with a first period of time, the motion information being related to a change in the interactive scene within the first period of time;
generating, with the generation model, a second image token based on the first image token and the set of motion tokens, the second image token corresponding to a predicted image of the interactive scene at a second moment; and
determining, based on the first image and the predicted image, a trigger action in the interactive scene.

20. The computer program product of claim 19, wherein the set of motion tokens is a first set of motion tokens, the predicted image is a first predicted image, the trigger action is a first trigger action, and the operations further comprise:
obtaining a second image of the interactive scene at the second moment;
generating, with the generation model, a second set of motion tokens associated with a second period of time based on the first image token, the first set of motion tokens and a third image token corresponding to the second image;
generating, with the generation model, a fourth image token based on the first image token, the first set of motion tokens, the third image token and the second set of motion tokens, the fourth image token corresponding to a second predicted image of the interactive scene at a third moment; and
determining, based on the second image and the second predicted image, a second trigger action in the interactive scene.
